(19) United States
(12) Patent Application Publication
(10) Pub. No.: US 2004/0060160 A1
(43) Pub. Date: Apr. 1, 2004

(54) Method for joining rod and collar and joining die set therefor

(76) Inventors: Makoto Nishimura, Kanagawa-ken (JP); Hiroshi Murakami, Kanagawa-ken (JP)

Correspondence Address: WENDEROTH, LIND & PONACK, L.L.P., 2033 K STREET N. W., SUITE 800, WASHINGTON, DC, 20006-1021, US

(21) Appl. No.: 10/620,609

(22) Filed: Jul. 17, 2003

(30) Foreign Application Priority Data
Jan. 31, 2002 (JP) 24489/2002

(51) Int. Cl. B23P 11/00

(52) U.S. Cl. 29/525; 29/525.08; 29/523; 29/443

(57) ABSTRACT

After a rod 4 with a pre-formed annular groove 21 is fixed on a reception die 26, a collar blank 23 is fitted on the rod 4. Then the die 25 is advanced toward the reception die 26 along the rod 4, urging the collar blank 23 into its forming bore 27, causing the inner diameter portion of the blank 23 to enter into the annular groove 21 by a plastic flow. Subsequently by a further advancement of the die 25, an annular projection 29 formed at the bottom surface of the forming bore 27 is driven into the end surface of the collar blank 23 to cause the blank to 23 plastically flow further into the annular groove 21.

### BACKGROUND OF THE INVENTION

The present invention generally relates to a method for joining a collar to a rod for such as, for example, a hydraulic shock absorber, a cylinder device and the like by utilizing a plastic working process, and an optimum joining die set for use in implementing the method.

A hydraulic absorber is known, for example as shown in FIG. 14, wherein it is constructed such that it comprises an inner tube 2 accommodated in a bottomed outer tube 3, the inner tube having a piston 1 received therein for sliding, a rod (piston-rod) 4 connected at its one end with the piston 1 and extended outwardly at its opposite end passing through a rod guide 5 engaged jointly with opened ends of the inner and outer tubes 2 and 3, piston valves 6 provided at the piston 1, and a base valve 7 provided at the inner bottom of the outer tube 3. These piston and base valves serve to create damping forces during extension and compression strokes of the piston by allowing hydraulic fluid filled in the inner tube 2 to pass through these valves. The change in volume of the hydraulic fluid in extension and compression strokes of the piston rod 4 may be compensated for by means of a reservoir 8 in which gas and hydraulic fluid are filled between the inner and outer tubes 2 and 3.

In such a case that this type of hydraulic shock absorber is used as a vehicle suspension, there are formed, an eye 10 at the bottom end of the outer tube 3 as a mount to an axle side, a collar portion 11 and a thread portion 12 on the tip end side of the rod 4 as a mount to a vehicle body, and a spring receiver 13 on an intermediate portion of the outer tube 3 for receiving a coil spring. In this case, the collar portion 11 and the thread portion 12 are formed on the tip side of the rod 4 in a shape just like that of an upright bolt. Accordingly, it has been a common practice to join the bolt integrally at the tip of the rod 4 in a conventional configuration utilizing projection welding (weld portion W) such that the bolt head may abut against the tip of the rod 4. A hydraulic shock absorber as shown, for example, in the Japanese Patent Unexamined Application Publication No. HEI5-26272 in its FIG. 5, represents the above-noted configuration in which the bolt is joined to the rod through projection welding.

However, the aforementioned approach by which the bolt is joined to the rod 4 through the projection welding suffers from many difficulties, including the need of strictly controlling welding parameters, i.e., welding current and compression forces to be applied, along with the need of maintaining the surface quality level of the rod 4 and the bolt to be used at a constant level, so as to ensure a desirable joint strength. Another problem which may occur is that strain may be easily created due to thermal effects during welding operation, and thereby requiring a cumbersome strain-relieving operation to be taken with rather frequent intervals.

### SUMMARY OF THE INVENTION

The present invention has been achieved with the aforementioned problem as a background, and it is an object of the present invention to provide a method for joining a rod and a collar by which a separate collar and a rod can be joined together in a simple and reliable manner utilizing a plastic working process, and a joining die set optimum for use in implementing the joining method.

In order to solve the aforementioned problem, the method for joining is characterized in that it comprises a first step of fitting a collar blank onto a rod in which an annular groove has been formed, a second step of squeezing the collar blank through swaging operation and then causing the collar blank to enter into the annular groove due to a plastic flow, and a third step of upsetting the blank while restraining the blank at its outer periphery and then causing the blank to further enter into the annular groove due to a plastic flow.

In accordance with the method for joining a rod and a collar as above-described, the blank can completely fill the annular groove in the rod by applying a combined working process consisting of a first step of causing the collar blank to enter into the annular groove in the rod due to a plastic flow through swaging operation and a step of subsequently upsetting the collar blank to provide a further plastic flow into the annular groove.

Alternatively, the method of the present invention may be implemented by upsetting a collar blank locally, and besides, the second and third steps may be continuously effectuated using the same die set. Further, the present invention may use a plurality of rings, which have been formed by blanking a sheet material to provide a collar blank.

In addition, the method of the present invention may form a protrusion along a circumferential direction in the annular groove in the rod, and thereby allowing the material of a blank to be evenly distributed into the annular groove. Further, the blank may be formed such that its cross-section is progressively decreased toward the rear side in the direction of swaging operation. Thus, a possible deformation of the blank that would otherwise occur after swaging operation, can be prevented.

To solve the aforementioned problem, the joining die set in accordance with the present invention comprises a die and a reception die each having a hole through which a rod may be inserted, the die including a forming bore portion which restrains a collar blank at its outer periphery, the reception die including a punch portion which may be accommodated in a forming bore in the die. These forming bore and punch portion are defined around the rod-insertion bores. The die also has an annular protrusion at the bottom surface of the forming bore portion which is driven into the end surface of said the collar blank.

In the joining die set as constructed as aforementioned, first and second steps in the aforementioned joining method may be carried out continuously by allowing a relative movement between the die and the reception die on the rod.

Further, in addition to the construction of the joining die set as aforementioned, the reception die may be formed in a longitudinally-split construction which is separable along the axial direction of said rod. Thus, the reception die can be split to set a rod so as to protect the sliding surface of the rod from any damage.

### BRIEF DESCRIPTION OF THE DRAWING

FIG. 1 is a process chart showing how the method for joining a rod and a collar together can be implemented in accordance with the present invention;

FIG. 2 is a side elevation showing in partial cross-section the shape of the rod and the collar to be prepared in carrying out the joining method in the first embodiment of the present invention;

FIG. 3 is a cross-section showing the structure of a joining die set for the rod and collar in accordance with the first embodiment of the present invention;

FIG. 4 is a cross-section showing how the collar may be joined to the rod in the joining method in accordance with the first embodiment of the present invention;

FIG. 5 is a cross-section showing another configuration in which the collar may be joined with the rod in the joining method in accordance with the first embodiment of the present invention;

FIG. 6 is a cross-section showing an alternative structure of the joining die set for the rod and the collar in accordance with the first embodiment of the present invention;

FIG. 7 is an enlarged view showing an annular groove in the rod to be used in the method for joining the rod and collar in accordance with the present invention;

FIG. 8 is an enlarged longitudinal cross-section showing a collar blank to be used in the method for joining the rod and the collar in accordance with a second embodiment of the present invention;

FIG. 9 is an enlarged longitudinal sectional view showing a variation of a blank to be used in the method for joining the rod and the collar in accordance with the second embodiment of the present invention;

FIG. 10 is an enlarged longitudinal sectional view showing another variation of a blank to be used in the method for joining the rod and the collar in accordance with the second embodiment of the present invention;

FIG. 11 is an enlarged longitudinal sectional view showing a die in the joining die set of the rod and the collar in accordance with the second embodiment of the present invention;

FIG. 12 is a pictorial view showing a first step in the method for joining the rod and the collar in accordance with the second embodiment of the present invention;

FIG. 13 is a pictorial view showing second and third steps in the method for joining the rod and the collar in accordance with the second embodiment of the present invention; and

FIG. 14 is a cross-section showing the entire structure of a hydraulic shock absorber which is a work piece in the present invention.

### DETAILED DESCRIPTION OF THE INVENTION

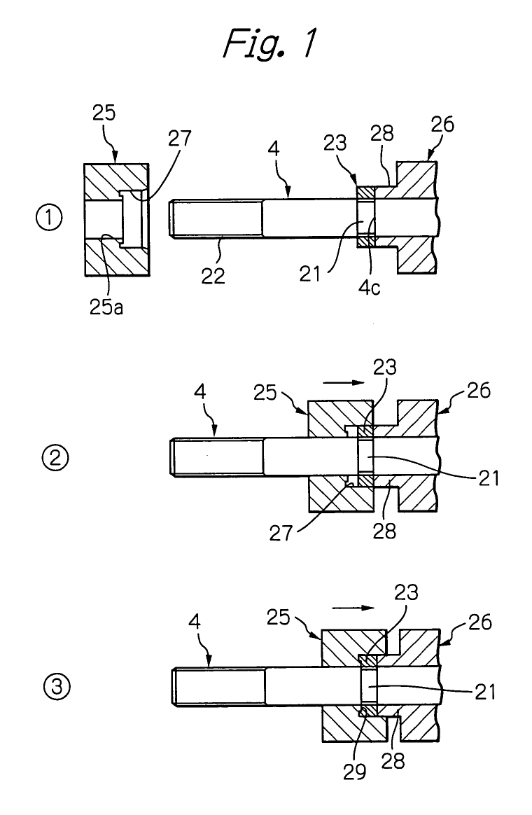

Now, a first embodiment of the present invention will be described with reference to accompanying drawings FIG. 1-FIG. 6.

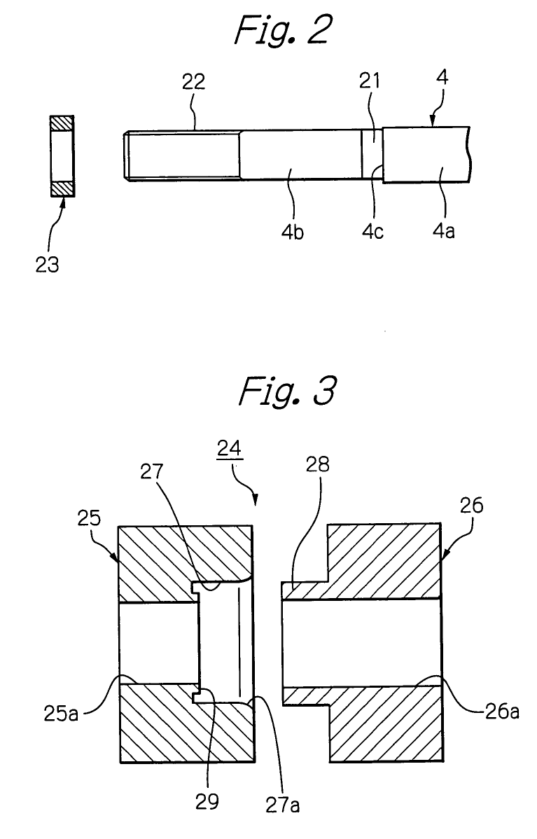

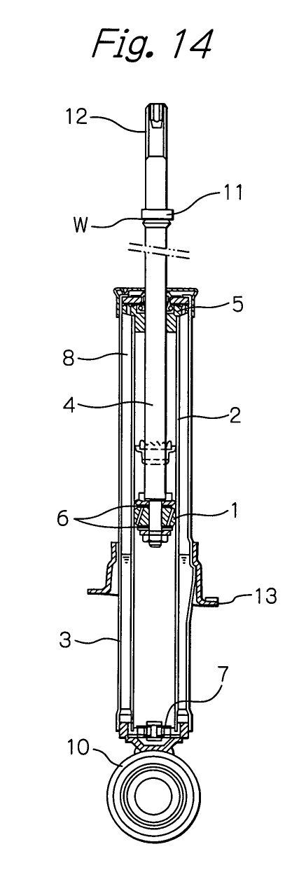

FIG. 1 shows a method for joining a rod and a collar together in accordance with the first embodiment of the present invention. The present embodiment contemplates joining a separate collar 20 (corresponding to the collar portion 11 in FIG. 14) integrally with the rod (piston rod) 4 in the hydraulic shock absorber as shown in FIG. 14, utilizing a plastic working process, and when the present invention is implemented, an annular groove 21 is formed beforehand in a portion of the rod 4 where the collar 20 is to be joined, as shown in FIG. 2, and a thread portion 22 (corresponding to the thread portion 12 in FIG. 14) is formed at the tip end of the rod 4. The rod 4 is formed with a diameter at the tip side portion 4b which is on the distal side from the joint portion of the collar 20 slightly smaller (e.g., 12.0 mm) than the rod diameter of the body portion 4a (e.g., 12.5 mm). The aforementioned annular groove 21 is formed adjacent the step 4c of the boundary between aforementioned body portion 4a and the tip side portion 4b. Depth and width of the annular groove 21 should be selected to be sufficient to ensure resistance to the removal necessary for the collar 20 where the above-described hydraulic shock absorber is used in a suspension. By way of non-limiting example, this annular groove 21 should be defined having approximately 0.65 mm in depth and 8.0 mm in width. Meanwhile, the rod 4 may be formed either in a straight configuration rather than a stepped shape, or enlarged stepped shape. By forming minute surface convexes and concaves in the bottom surface of the annular groove 21 beforehand, it may become possible to ensure increased resistance to removal of the collar.

In embodying the present invention, a collar blank 23 is prepared beforehand with substantially the same shape as that of the aforementioned collar 20. The collar blank (simply the blank hereinafter) 23 is formed with an inner diameter selected such that it may form a suitable clearance (approximately 0.1-0.2 mm) between itself and the rod tip side portion 4b, and consequently the blank 23 can engage with the rod 4 in a rather loose fashion. The blank 23 is also formed with a height slightly smaller than the width of the annular groove 21 formed on the aforementioned rod 4. Any available method may be used for forming this blank 23, but a usual cold forging process may be employed due to the fact that the blank may engages with the rod 4 in a loose fashion. In this case, a continuous forging machine such as a nut-former may be desirably used, because it may readily be adapted to a mass-production and manufacture at a relatively low cost. A skew form rolling may be used to cut a thick-wall pipe into blanks.

In accordance with the embodiment of the present invention, a swaging machine (not shown) is utilized to achieve plastic working, and therefore a die set (joining die set) for this particular purpose should be provided beforehand. This joining die set 24 consists of a die 25 which has a rod-insertion bore 25a at its center, and a reception die 26 which likewise has a rod-insertion bore 26a at its center, as shown in FIG. 3. The die 25 has a forming bore portion 27 which restrains the periphery of aforementioned blank 23 and the die 26 has a punch portion 28 which may be inserted into the forming bore portion 27 in the die 25. These forming bore portion 27 and the punch portion 28 are formed around the rod-insertion bores 25a and 26a respectively. The die 25 is further provided at the bottom surface of its forming bore portion 27 with an annular protrusion 29 adapted to be driven into the end surface of the blank 23. A tapered inlet portion 27a is defined at the peripheral portion of the inlet edge of the forming bore portion 27 of the die 25 so as to facilitate fitting of the blank 23 into the forming bore portion 27. The die 25 is arranged at the movable portion of the swaging machine and the reception die 26 is arranged at the immovable portion respectively, although it does not matter whichever the die 25 and reception die 26 comprising the joining die set 24 is arranged on the movable side. It is a matter of option whether an annular protrusion 29 defined on the bottom surface of the forming bore portion 27 is embodied either as a circumferentially continuous or discontinuous protrusion.

Then, a method for joining the rod and collar together in accordance with the present invention will be described in details hereinafter.

(First Step)

First, the rod 4 in which an annular groove 21 and a thread 22 have been formed beforehand is fitted to the reception die 26 arranged on the immovable portion of the swaging machine, as shown in Section \mathring{1} of FIG. 1, and subsequently the blank 23 is fitted onto this rod 4. At this instance, the rod 4 should be positioned such that its step 4c is aligned with the end surface of the punch 28 of the reception die 26, and the blank 23 is fitted onto the rod 4 until it comes to abut against the end surface of the punch 28 of the reception die 26, thereby allowing the blank 23 to be positioned in alignment with the annular groove 21 in the rod 4. In this case, because the blank 23 and the rod 4 engage with each other in a loose fashion, as previously described, the blank 23 may be fitted onto the rod 4 easily.

(Second Step)

Then, the die 25 arranged on the movable portion of the swaging machine is caused to move (advance) integrally with the movable portion, and approaches toward the reception die 26 while allowing the rod 4 to pass through its insertion bore 25a. Consequently, since its back surface is restrained by means of the reception die 26, the blank 23 is inserted into the forming bore 27 in the die 25 via the inlet portion 27a, thereby allowing the blank 23 to be squeezed. That is, as swaging (parallel swaging) operation proceeds, the blank 23 creates a plastic flow into the annular groove 21 accordingly, and the inner diameter side of the blank 23 is fitted into the annular groove 21. At this instance, because the blank 23 is free from any restraining action from the forming die 24 at one side (a side opposite the punch side 28), it is elongated slightly in an axial direction. Thus, the annular groove 21 is not completely filled with the blank 23 at its early stage of operation.

(Third Step)

The die 25 continues to proceed forwardly after the completion of aforementioned swaging operation (after the completion of the second step), and eventually the blank 23 comes into contact with the bottom surface of the forming bore portion 27 at its one end, as shown in Section \mathring{3} of FIG. 1. An annular protrusion 29 is formed on the bottom surface of the forming bore portion 27, and the annular protrusion 29 is driven progressively into the blank 23 with the further advancement of the die 25. That is, the blank 23 is brought into a condition in which it has been upset to cause a plastic flow into the annular groove 21 again, and thereby allowing the annular groove 21 to be completely filled with the blank 23. Subsequently, the die 25 is drawn from the rod 4 integrally with the movable portion of the swaging machine, and thus joint of the blank 23 (collar 20) with the rod 4 is be completed.

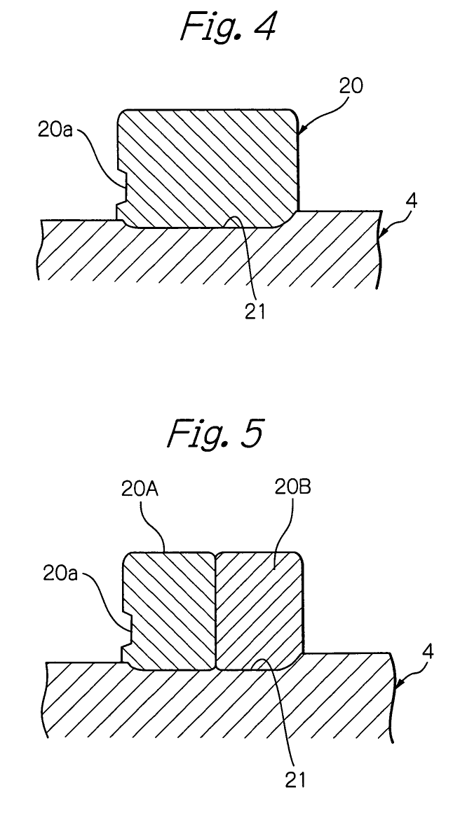

FIG. 4 is a view showing the status when the aforementioned joining has been completed, wherein the collar 20 fully occupies the annular groove 21 in the rod 4 with no clearance, and consequently its resistance to removable becomes sufficient. In the meantime, the collar 20 has a recess 20a at its end surface that has been left as an imprint of penetration of the annular protrusion 29.

In a method for joining the rod and collar to be implemented as previously described, a combined working operation is effectuated in which the blank 23 is first caused to enter into the annular groove 21 in the rod 4 with a plastic flow, and subsequently the blank 23 is upset to further plastically flow into the annular groove 21, the flow of the material becomes smooth, thereby allowing a separate collar 20 to be firmly joined to the rod 4. Besides, since the blank 23 is first squeezed through a swaging operation, engagement of the blank 23 with the rod 4 may be made loose and therefore smooth, and correspondingly the blank 23 may be worked roughly utilizing a cold forging operation etc., resulting in a significantly reduced manufacturing cost of the blank to be prepared beforehand. To the contrary, if the material is caused to make in a plastic flow solely by an upsetting, a tight initial engagement must be established for the blank 23 with the rod 4, and in this case, a highly precise working process is required, resulting in a substantial increase of the manufacturing cost of the blank.

Further, because the working pressure may be distributed by means of aforementioned combined working operation, a necessary working pressure may be reduced, and a small swaging machine may suffice the need. In the embodiment especially, the upsetting operation in the later stages is carried out in such a condition that the annular protrusion 29 is caused locally to be driven into the blank 23. Therefore, working pressure used may be further reduced.

The present invention may be achieved in such a way that the aforementioned collar 20 is split (bisected in this case) into a plurality of elements, and split elements 20A and 20B are driven into the annular groove 21 in the rod 4. In such a case, aforementioned collar (23) will be prepared beforehand to have a plural number so as to correspond with the number of the split elements 20A and 20B, and due to the fact that height (thickness) of the blank element to be prepared is reduced, it is possible to produce blanks from a sheet material through blanking process, whereby lowering the manufacturing cost of the blanks in comparison with the case of the blanks 23 made through cold-forging process.

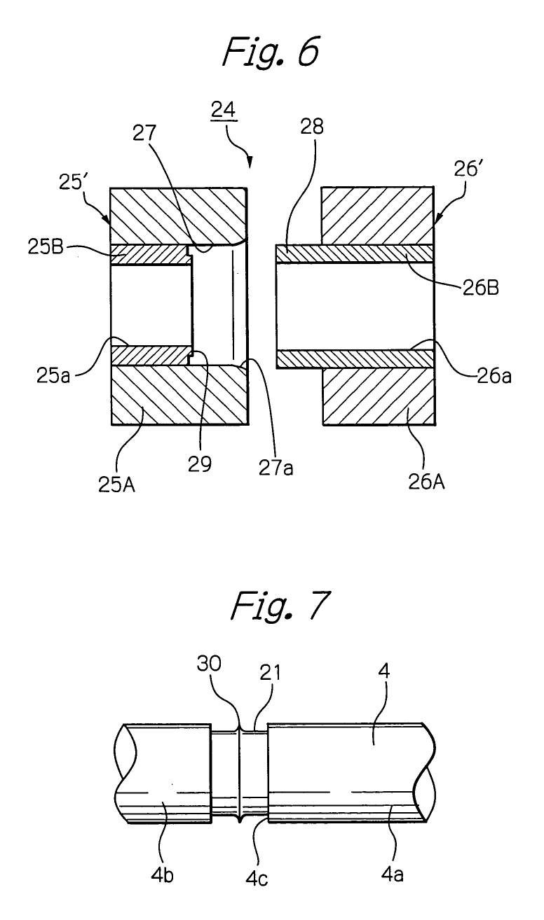

Alternatively, the die 25 and the reception die 26 as shown in FIG. 3 may be manufactured in a simpler manner, and may be formed in a composite construction, as shown in FIG. 6, so to as accommodate various rods of different specifications (rod diameter, and resistance to removal etc.,). That is, the die 25′ may comprise the die body 25A and the rod guide 25B which in turn includes the aforementioned insertion bore 25a and annular protrusion 29, and the reception die 26′ comprises the reception die body 26A and the rod guide 26B which in turn includes the aforementioned insertion bore 26a and the punch 28. The reception die 26A and the rod guide 26B are set at the stationary portion of the swaging machine, and on the other hand, the die body 25A and the rod guide 25B are arranged on the movable portion of the swaging machine, such that the die body 25A and the rod guide 25B may move in unison.

In this case, if a plurality of rod guides 25B and 26B are prepared, respectively, with different inner diameters, they may be exchanged suitably as needed, so that they can accommodate various rods with different rod diameters. Furthermore, if a plurality of rod guides 25B and 26B are prepared beforehand, respectively, with different axial lengths, i.e., if they have annular protrusions 29 and punchs 28 with different axial length, they may be exchanged suitably as needed, so that a variety of values of resistance to removable may be established for collars, resulting in an improved applicability.

Then, a second embodiment of the present invention will be described with reference to accompanying drawings FIG. 7 to FIG. 13. In the meantime, portions which are different from those in the aforementioned first embodiment will be described in details, while indicating similar parts with the same reference symbols.

In the present embodiment, the annular groove 21 in the rod 4 is formed with a central annular protrusion 30 extending in the circumferential direction, as shown in FIG. 7. Meanwhile, there may be a plurality of protrusions 30 or the protrusion 30 may be formed in a spiral configuration.

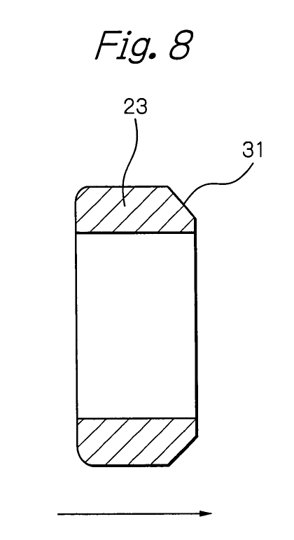

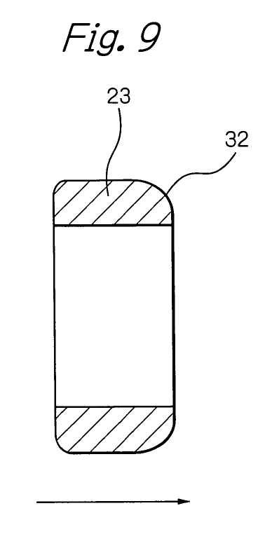

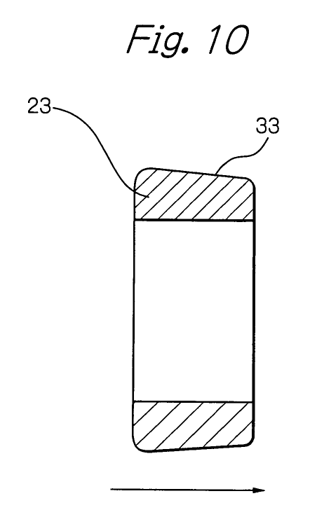

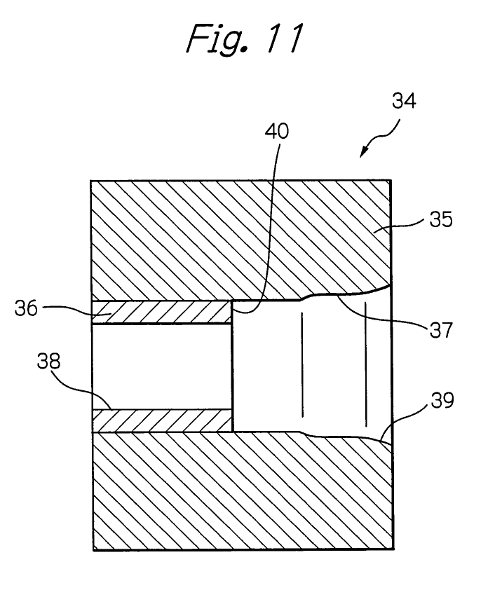

The blank 23 is formed with a chamfered portion 31 over the outer peripheral portion at its one end, as shown in FIG. 8, having such a shape that its cross-sectional area decreases toward the rear side of the swaging operation (the direction designated by the arrow on FIG. 8). In the meantime, the blank 23 may alternatively be formed such that its volume decreases toward the rear side of the swaging operation (refer the arrows in FIG. 9 and FIG. 10) by forming a rounded contour area 32 along the outer periphery of one end, as shown in FIG. 9, or forming the outer periphery 33 tapered, as shown in FIG. 10, or alternatively combining a plurality of rings with different diameters (e.g. by reducing the diameters of the split element 20B so that it becomes less than that of the split element 20A in the embodiment shown in FIG. 5).

Referring to FIG. 11, there is shown a die set 34 of a composite structure consisting of a die body 35 and a rod guide portion 36, and the die body 35 is formed with a forming bore portion 37 that restrains the outer periphery of the blank 23, whereas the rod guide portion 36 is formed with an insertion bore 38 into which the tip side portion 4b of the rod may be inserted. The forming bore portion 37 is formed to have a smoothly stepped configuration (i.e., shape to effect multi-stage squeezing), having a slightly enlarged tapered inlet portion 39. Meanwhile, although the forming bore portion 37 is formed to have a two-stepped portions in the illustrated configuration, it may alternatively be formed to have three or more-stepped portions. The rod guide 36 has no annular protrusion at the end surface 40 on the side of the forming bore portion 37. The end surface is made as a smooth surface.

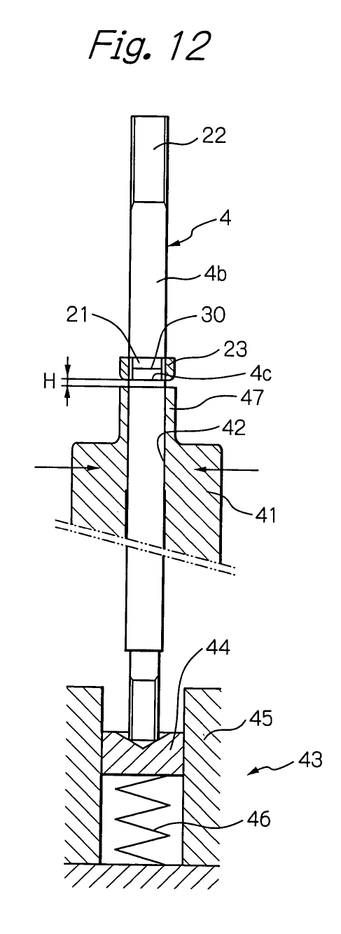

Referring to FIG. 12, a reception die 41 is of a longitudinally split construction which is separable along an axial direction, and is adapted to receive the rod 4 in an insertion bore 42 without damaging the sliding portion of the rod 4, by moving the split die sections in the direction of the arrows so as to be combined, after the rod 4 is inserted through the space between the split die sections.

As shown in FIG. 12, the swaging machine in accordance with the present embodiment is provided with a lower receiving pedestal 43 which supports one end of the rod 40. The lower receiving pedestal 43 is designed such that a rod receiver 44 for receiving one end of the rod 4 is guided to move along the axial direction of the rod 4, and is resiliently supported in position by means of spring 46 so that the rod 4 that is set on the swaging machine is resiliently supported to be movable along the axial direction.

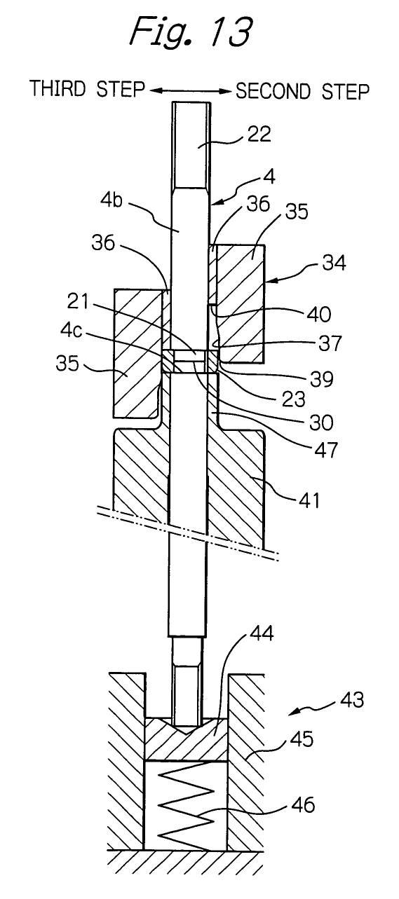

Then, several steps in the method for joining the rod and the collar together in accordance with the present invention will be described, with reference to FIG. 12 and FIG. 13.

(First Step)

Referring to FIG. 12, the rod 4 is inserted into the receiving split die 41 to abut against the rod receiver 44 in the lower receiving pedestal 43 to be fixed to the reception die 41, and then the rod 4 is set on the swaging machine. By forming the reception die 41 in a longitudinally split configuration, any inconveniency, which may be caused by a damaged sliding surface such as poor sealing and rust formation can be prevented, because the sliding surface of the rod 4 is not damaged when the rod 4 is being installed in the swaging machine.

Then, the blank 23 is fitted onto the annular groove 21, and the end surface at the side of the chamfered portion 31 (or alternatively the side of rounded portion 32, small-diameter side of the tapered portion 33 or smaller-diameter ring side) is caused to abut against the step 4c. At this instance, the stepped portion 4c is caused to protrude slightly beyond the tip of the punch 47 (distance of protrusion is indicated with H). In this manner, the blank 23 is caused to abut against the stepped portion 4c on the rod 4, without being made to abut against the punch portion 47 on the reception die 41, and a clearance H is left between the blank 23 and the tip end of the punch 47.

(Second Step)

Referring to the right-half of FIG. 13, when the die 34 is lowered and the inlet portion 39 of the die 34 is caused to engage the blank 23, the spring 46 on the receiving pedestal 43 is compressed to move the rod 4 in a downward direction, allowing the end surface of the blank 23 to abut against the tip end of the punch 47 on the reception die 41. In this way, a difference in the axial length (position of the annular groove 21) of the rod 4 may be automatically adjusted. Further, when the die 34 is lowered, the blank 23 is swaged by means of forming bore portion 37 of die 34 having a stepped shape, and can enter into the annular groove 21 in the rod 4 due to a plastic flow.

At this moment, as the blank 23 is squeezed in a step-wise fashion by means of forming bore 37 having a stepped shape, the blank 23 may fill evenly the annular groove 21. Also, a possible flow of the blank 23 toward the punch portion side 4 by a dragging action of the die 34 may be suppressed by the protrusion 30, and thereby preventing uneven distribution of the material of blank 23 to fill the annular groove 21. Further, after working operation is completed, the shape of the protrusion 30 may be transferred to the blank 23, and thus a shear strength at the joint between the rod 4 and the collar 20 may be increased.

(Third Step)

Further, referring to the left half of FIG. 13, when the die 34 is further caused to lower, the punch portion 47 may be inserted into the forming bore 37, and the blank 23 is upset for further plastic flow, and thence perfectly fills the annular groove 21. Thereafter, the die 34 is raised and the reception die 41 is opened to release the rod 4. In this way, the collar 20 is joined to the rod 4.

At this instance, since the blank 23 is formed to have a decreasing cross-section toward its one end by means of chamfered portion 31, the rounded portion 32, tapered outer surface 33 or a smaller-diameter ring, it becomes possible to prevent the blank 23 from being locally deformed under a dragging action of the die 34. More particularly, the material of the blank is prevented from entering into a gap between the punch 47 and the die 34 in a condition as shown in the left side in FIG. 13, and thereby preventing creation of burrs etc.,. Because the end surface of the collar 20 on the thread side 12 of the rod 4 is formed to be flat, by forming the end surface 40 of the rod guide 36 of the die 34 to be flat, an effective pressure bearing area of the collar 20 is enlarged to advantageously increase an allowable load.

In the meantime, although it is arranged to automatically adjust difference in length (position of annular groove 21) of the rod 4 by providing the spring 46 in the lower receiving pedestal 43 in the swaging machine, reaction of the rod to be created by a gas in the shock absorber after assembly, may be utilized instead of resiliency of the spring 4, when the collar is to be joined with the rod of a gas-filled type hydraulic shock absorber.

As aforementioned, in the method for joining the rod and the collar together in accordance with the present invention, a combined working process of swaging and upsetting operations is applied to a blank of a collar, and thus the collar may be easily and reliably joined with the rod into a unitary body. Therefore, the invention proves a very advantageous method, in comparison with a conventional welding process.

In the aforementioned upsetting, a working pressure needed may be reduced, when the blank is locally compressed.

Besides, when the combined working process as noted above is to be achieved continuously using the same dies, the need of shifting materials among a plurality of working station may be eliminated, and thus a cost needed in the joining step may be lowered.

Further, when a plurality of rings, which have been formed by blanking a sheet material are used as is the case in one of the above-described blanks, their production cost may be reduced since manufacture of such blanks can be achieved simply by blanking pieces from a sheet material.

By forming a protrusion in the annular groove in the rod, the collar blank can be evenly distributed in the annular groove. Further, by forming the collar blank to have a shape that its cross-section decreases toward the rear side in the swaging direction, a possible deformation of the material of the blank after swaging operation can be suppressed to prevent creation of burrs etc.,

On the other hand, in the joining die set of the rod and collar in accordance with the present invention, the aforementioned combined working can be carried out continuously under a reduced working pressure, by simply moving the die and the reception die relative to each other, resulting in achieving a significant advantage from the practical point of view.

In addition to the aforementioned arrangement of the joining die set, by forming the reception die in a longitudinally split structure, a possible damage to the sliding surface of a rod may be prevented, and thereby preventing inconveniences such as poor sealing characteristic and rust development etc., due to a damaged sliding surface which could be caused when the rod is being set in position.

What is claimed is:

1. A method for joining a rod and a collar together, comprising:
a first step of fitting a collar blank onto a rod in which an annular groove has been formed;
a second step of squeezing said collar blank by a swaging process to cause a plastic flow of the material of the blank into said groove; and
a third step of upsetting said blank while restraining the outer periphery of the blank so as to cause a further plastic flow into said annular groove.

2. A method for joining a rod and a collar together in accordance with claim 1, wherein the third step includes a process of locally upsetting the blank.

3. A method for joining a rod and a collar together in accordance with claim 1, wherein the second and third steps are achieved continuously using the same die set.

4. A method for joining a rod and a collar together in accordance with claim 2, wherein the second and third steps are achieved continuously using the same die set.

5. A method for joining a rod and a collar together in accordance with claim 1, wherein a plurality of rings which have been blanked out of a sheet material are used as the blank.

6. A method for joining a rod and a collar together in accordance with claim 2, wherein a plurality of rings which have been blanked out of a sheet material are used as the blank.

7. A method for joining a rod and a collar together in accordance with claim 3, wherein a plurality of rings which have been blanked out of a sheet material are used as the blank.

8. A method for joining a rod and a collar together in accordance with claim 4, wherein a plurality of rings which have been blanked out of a sheet material is used as the blank.

9. A method for joining a rod and a collar together in accordance with claim 1, wherein said annular groove in said rod is provided with a protrusion extending along the circumferential direction.

10. A method for joining a rod and a collar together in accordance with claim 2, wherein said annular groove in said rod is provided with a protrusion extending along the circumferential direction.

11. A method for joining a rod and a collar together in accordance with claim 3, wherein said annular groove in said rod is provided with a protrusion extending along the circumferential direction.

12. A method for joining a rod and a collar together in accordance with claim 4, wherein said annular groove in said rod is provided with a protrusion extending along the circumferential direction

13. A method for joining a rod and a collar together in accordance with claim 1, wherein said blank is made in such a shape that its cross-section decreases progressively toward the rear side of the swaging direction.

14. A method for joining a rod and a collar together in accordance with claim 2, wherein said blank is made in such a shape that its cross-section decreases progressively toward the rear side of the swaging direction.

15. A method for joining a rod and a collar together in accordance with claim 3, wherein said blank is made in such a shape that its cross-section decreases progressively toward the rear side of the swaging direction.

16. A method for joining a rod and a collar together in accordance with claim 4, wherein said blank is made in such a shape that its cross-section decreases progressively toward the rear side of the swaging direction.

17. A die set for joining a rod and a collar together, wherein said die set comprises a die and a reception die each having a bore through which the rod can be inserted, said die having a forming bore which restrains the outer circumference of a collar blank fitted on said rod, said reception die having a punch portion which can be inserted into said forming bore of said die set, said forming bore and said punch being formed around the insertion bores for the rod respectively, and wherein said die has an annular projection formed on the bottom surface of the forming bore so that it can be driven into the facing end surface of said blank.

18. A die set for joining a rod and a collar together in accordance with claim 17, wherein said reception die is formed in a split construction which is separable along the axial direction of said rod.
